(19) United States
(12) Patent Application Publication
(10) Pub. No.: US 2008/0244063 A1
(43) Pub. Date: Oct. 2, 2008

(54) Automatically detecting managed servers in a network

(76) Inventor: Vinayak Risbud, Bangalore (IN)

Correspondence Address: TROP PRUNER & HU, PC, 1616 S. VOSS ROAD, SUITE 750, HOUSTON, TX, 77057-2631, US

(21) Appl. No.: 11/728,455

(22) Filed: Mar. 26, 2007

(51) Int. Cl. G06F 15/173

(52) U.S. Cl. 709/224

(57) ABSTRACT

A group of managed servers may be monitored by initially querying the network to determine which servers are present. The present servers may be identified by a universal unique identifier and their Internet Protocol address. A table may be maintained to correlate the Internet Protocol address and the universal unique identifier.

### BACKGROUND

This relates generally to managing servers in a network.

A managed server has a management controller adhering to the Intelligent Platform Management Interface Specification (“IPMI specification”), (see Version 2.0, Jul. 26, 2005, available from Intel Corp., Santa Clara, Calif.) and can be managed remotely or locally. A management desktop console may be used to manage a group of managed servers.

### BRIEF DESCRIPTION OF THE DRAWINGS

FIG. 1 is schematic depiction of one embodiment of the present invention; and

FIG. 2 is a flow chart for one embodiment of the present invention.

### DETAILED DESCRIPTION

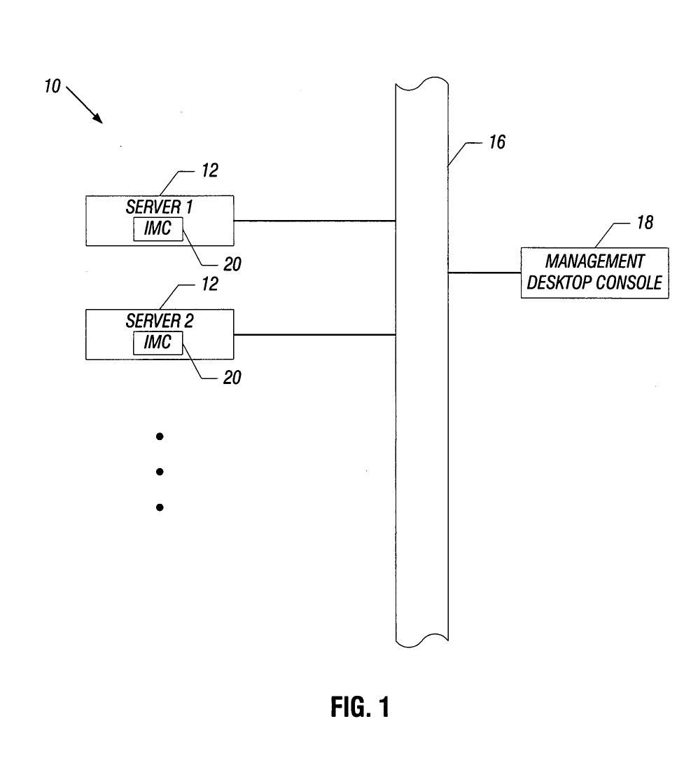

Referring to FIG. 1, a network 10 may include a number of managed servers 12, coupled by a network connection 16, which may be wired or wireless, to a management desktop console 18. The management desktop console 18 manages the managed servers 12. While two managed servers are depicted, many more managed servers may be utilized. Each of the managed servers 12 may include an integrated management controller 20 which may be utilized by the management desktop console 18 to manage the servers 12.

Each management controller 20 is assigned a universal unique identifier. The universal unique identifier is 128 bits wide and may be generated using a generally available algorithm. A universal unique identifier is guaranteed to be different from all other universal unique identifiers generated until 3400 A.D.

A universal unique identifier resolution protocol (URP) allows host/management desktop console 18 to find all the integrated management controllers 20 present in the network. It also allows the management desktop console 18 to find the universal unique identifier assigned to management controller 20. A reverse universal unique identifier resolution protocol (RURP) allows a host/management desktop console 18 to find an Internet Protocol address assigned to a management controller 20 given its universal unique identifier.

The URP/RURP packet header may include destination and source MAC addresses and an indication of whether the packet is a URP or RURP packet. The packet data format may include fields for hardware type and protocol type and size, an indication of whether the packet is a request packet or a response packet, the sender and target universal unique identifier and the sender and target Internet Protocol address.

To perform the scan of all management controllers 20 present in the network, management desktop console 18 broadcasts an URP packet with the Internet Protocol address of sender as ff.ff.ff.ff. All management controllers 20 present in the network will respond to this broadcast packet with their universal unique identifier and Internet Protocol address (if already assigned).

A host/management desktop console 18 looking for the universal unique identifier of a controller with a known Internet Protocol address sends a broadcast message using a URP request packet. The controller 20 with that Internet Protocol address responds with its universal unique identifier using the URP response packet.

A host/management desktop console 18 looking for the Internet Protocol address of a controller 20 with a known universal unique identifier sends a broadcast message using a RURP request packet. The controller 20 with that Internet Protocol address responds with its universal unique identifier using the RURP response packet.

The protocols can use caching techniques to maintain a table listing universal unique identifiers and Internet Protocol address mapping. A timeout may be used to flush out stale cached entries.

The integrated management controller 20 may keep track of all server activities that need to be managed. Managed activities may include fan control, system shutdown, power on, event logging, etc. The servers 12 are managed by a management desktop console 18 run on a desktop that interacts with the managed servers 12 per the IPMI specification.

The need arises to have a protocol to detect the managed servers 12 present on the network 10. The range of Internet Protocol addresses given by a user may be scanned to find the managed servers on the network 10. Thus, the management desktop console 18 is unable to detect managed servers 12 unless the user initiates the process, in one embodiment.

The management controllers 20 are assigned universal unique identifiers. The management desktop console 18 requests the universal unique identifier from all servers 12 present in the network 10 at regular intervals using the URP. In response to a URP request, the controllers 20 send URP response packets. Thus, the management desktop console 18 eventually learns of the existence of all the servers 12 on the network 10. If there is no response from a known server to a URP request packet, then the management desktop console 18 deletes the server from its known server list.

Thus, in some embodiments, there is no need to configure Internet Protocol addresses to initiate management of a server 12. Instead, the universal unique identifier can be used to discover the server 12 and also to configure the Internet Protocol address of that server. Discovery of managed servers need not require any input, such as Internet Protocol addresses, in some embodiments. Also, there may be no need to scan for servers since as soon as the server is plugged into the network, it will be detected by the management desktop console 18 that allows the user to manage the server. Similarly, if the server leaves the network, the management desktop console 18 removes the server from the list of managed servers. The method can detect conflicts in Internet Protocol addresses due to human errors and allow the user to reconfigure Internet Protocol addresses remotely.

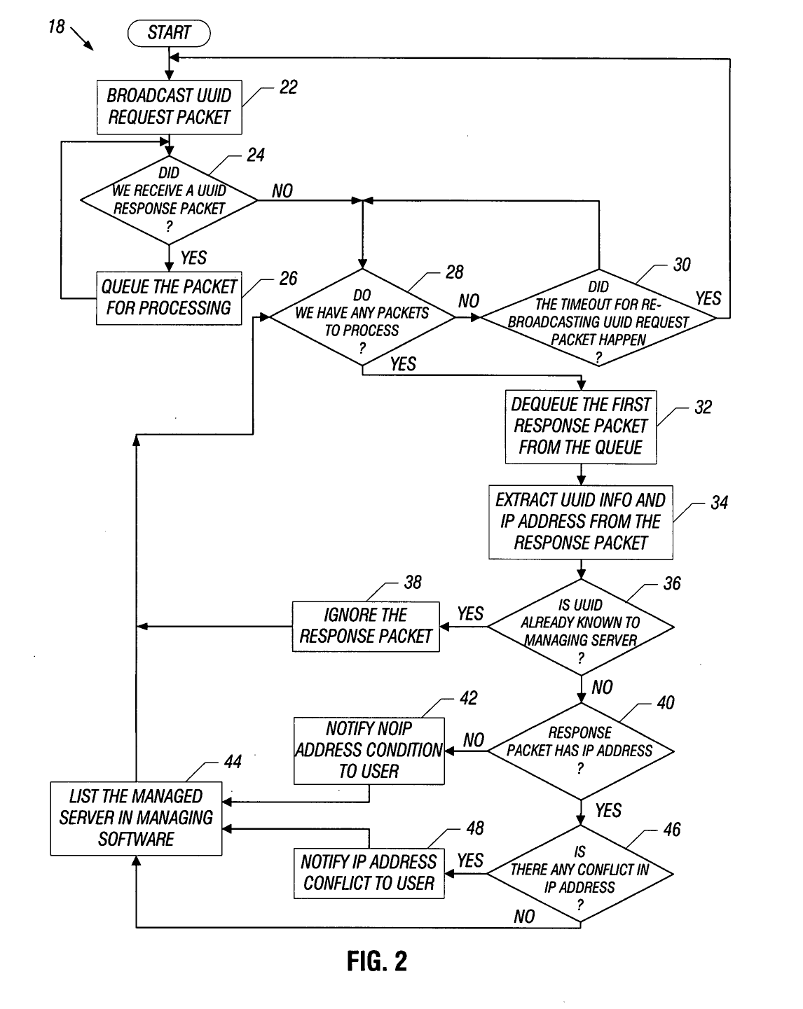

Referring to FIG. 2, the management desktop console 18 begins by broadcasting a universal unique identifier request packet (URP) as indicated at 22 with sender IP address ff.ff.ff.ff. It then waits for a URP response. All management controllers 20 present in the network respond to this URP request packet with their UUID and IPAddress (if already assigned). A check at diamond 24 indicates whether the response packet has been received. If so, the packet is queued for packet processing as indicated in block 26. If not, a check at diamond 28 determines whether there are any packets to process. Also, a check at diamond 30 determines whether there is a timeout for rebroadcasting universal unique identifier request packets. If there are packets to process, the first response packet is dequeued from the queue as indicated in block 32. The universal unique identifier and Internet Protocol address is extracted from the response packet as indicated in block 34.

A check at diamond 36 determines whether the universal unique identifier is already known to the management desktop console 18 as indicated in diamond 36. If so, the packet may be ignored (block 38) and the sequence returns back to diamond 28 to process another product. Otherwise, a check at diamond 40 determines whether the response packet includes an Internet Protocol address. If not, the user is notified in block 42, but the server is still listed in the managing software (block 44). If so, a check at diamond 46 determines whether there is any conflict in the Internet Protocol address. If so, the Internet Protocol address conflict is presented to the user, as indicated in block 48, but that server is still listed in the managing software at block 44. Otherwise, the managed server is listed in the management desktop console 18. The algorithm may be performed at regular intervals so that the servers are refreshed regularly in the management desktop console 18. After block 44, the flow iterates to diamond 25 to find more packets.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer readable medium storing instructions to enable a computer to:
periodically query a network to determine whether any new servers have been added to the network;
from each new server, request a universal unique identifier;
correlate a universal unique identifier and an Internet Protocol address; and
determine whether a server has left the network.

2. The medium of claim 1 wherein the instructions to periodically query a network include instructions to periodically query a network for new managed servers.

3. The medium of claim 2 including instructions to maintain a table that correlates universal unique identifiers to Internet Protocol addresses of said managed servers.

4. The medium of claim 3 including instructions to periodically determine whether a server has been removed from the network.

5. The medium of claim 1 including instructions to provide a user notification in response to a server that has no Internet Protocol address.

6. A medium of claim 1 including instructions to provide a user notification of conflict in Internet Protocol addresses between two servers.

7. A network comprising:
at least two servers; and
a management desktop console to determine when new servers have been added to said network or removed from said network, said management desktop console to query the network to determine the universal unique identifier for each new server and to correlate a universal unique identifier to an Internet Protocol address.

8. The network of claim 7 including at least two managed servers.

9. The network of claim 7 wherein said management desktop console to maintain a table to correlate universal unique identifiers to Internet Protocol addresses of said managed servers.

10. The network of claim 9, said management desktop console to provide a user notification response to a server that has no Internet Protocol address and the conflict of Internet Protocol addresses between two or more servers.

11. The network of claim 7, said management desktop console to query all of the servers in said network to determine a universal unique identifier for each server in said network.
